(19) United States
(12) Patent Application Publication
(10) Pub. No.: US 2025/0196195 A1
(43) Pub. Date: Jun. 19, 2025

(54) SYSTEM AND METHOD FOR STAIN REMOVAL FROM GARMENTS

(71) Applicant: LaundrySucks.io Inc., Sandy Springs, GA (US)

(72) Inventors: Thibault Corens, Sandy Springs, GA (US); Lafe Zabowski, Marietta, GA (US); Nishant Jain, Sandy Springs, GA (US)

(21) Appl. No.: 18/983,033

(22) Filed: Dec. 16, 2024

Related U.S. Application Data
(60) Provisional application No. 63/610,217, filed on Dec. 14, 2023.

(51) Int. Cl. B08B 3/02; B08B 3/10; B08B 13/00

(52) U.S. Cl. CPC B08B 3/02; B08B 3/10; B08B 13/00; B08B 2230/01; B08B 2240/00

(57) ABSTRACT

A method includes: accessing an image of a region of a garment located on a stage; extracting a set of features from the image; based on the set of features, detecting a stain in the region on the garment and interpreting a stain type of the stain; based on the stain type, selecting a cleaning fluid, from a set of cleaning fluids, for application onto the region of the garment. The method further includes, during a stain removal cycle: dispensing a volume of the cleaning fluid onto the region of the garment adjacent the stain via a nozzle facing the stage; and drawing air through the region of the garment and the stage via a vacuum subsystem facing the stage opposite the nozzle to remove the cleaning fluid and stain particles of the stain from the garment.

### CROSS-REFERENCE TO RELATED APPLICATIONS

This Application claims the benefit of U.S. Provisional Application No. 63/610,217 filed on 14 Dec. 2023, which is incorporated in its entirety by this reference.

This Application is related to U.S. patent application Ser. No. 17/258,531 filed on 7 Jan. 2021, which is incorporated in its entirety by this reference.

### TECHNICAL FIELD

This invention relates generally to the field of dry cleaning and, more specifically, to a new and useful method for autonomously removing a stain on a garment in the field of garment pressing and cleaning.

### BRIEF DESCRIPTION OF THE FIGURES

FIG. 1 is a flowchart representation of a method;

FIG. 2 is a flowchart representation of one variation of the method;

FIG. 3 is a schematic representation of a system;

FIG. 4 is a schematic representation of one variation of the system; and

FIG. 5 is a flowchart representation of one variation of the method.

### DESCRIPTION OF THE EMBODIMENTS

The following description of embodiments of the invention is not intended to limit the invention to these embodiments but rather to enable a person skilled in the art to make and use this invention. Variations, configurations, implementations, example implementations, and examples described herein are optional and are not exclusive to the variations, configurations, implementations, example implementations, and examples they describe. The invention described herein can include any and all permutations of these variations, configurations, implementations, example implementations, and examples.

### 1. Stain Removal System

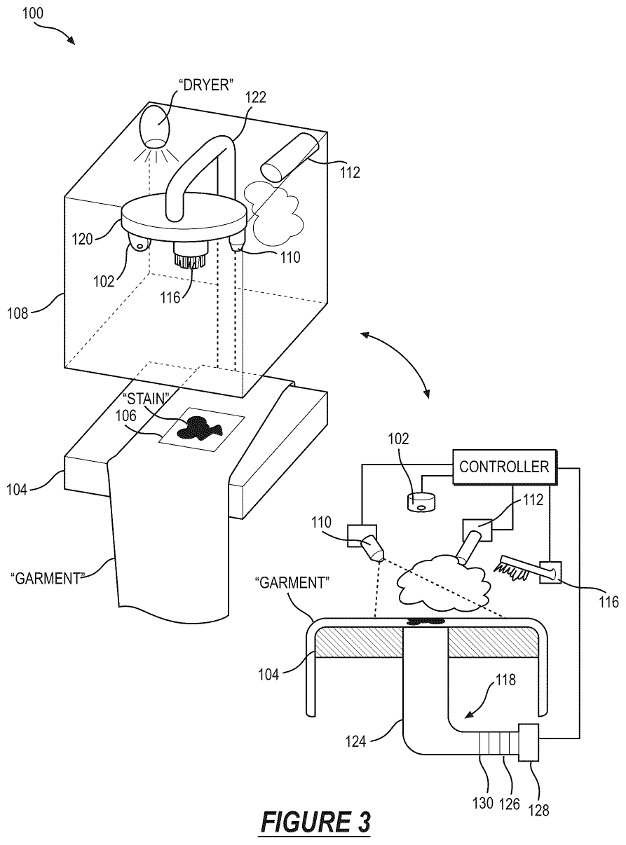

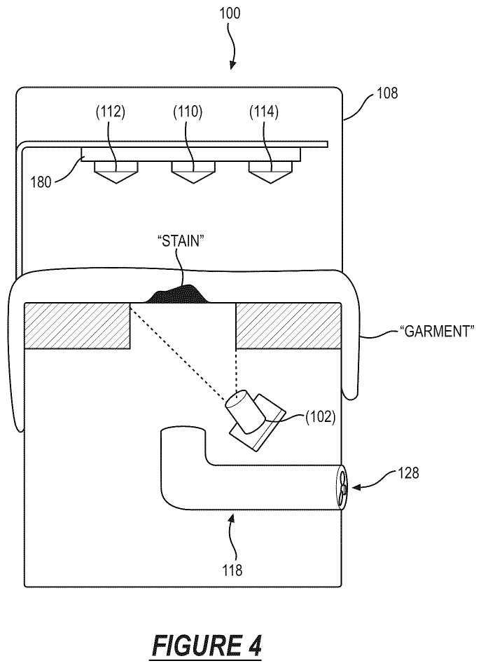

As shown in FIGS. 3 and 4, a stain removal system 100 includes: a stage 104 (or “platform”) configured to receive a stained region of a garment and including a window defining a stain removal work zone 106; an optical sensor 102 arranged over the stage 104, defining a field of view directed toward the stain removal work zone 106, and configured to capture an image of the stained region of the garment; and a cleaning fluid nozzle 110 arranged over the stage 104, defining a nozzle axis directed toward the stain removal work zone 106, and configured to project cleaning fluid along the nozzle axis toward the stained region of the garment to remove a stain from the stained region of the garment.

The stain removal system 100 also includes a steam nozzle 112: arranged over the stage 104 and defining a nozzle axis directed toward the stain removal work zone 106; and configured to direct a jet of steam along the nozzle axis toward the stain removal zone to tension the stained region of the garment across the window, enhance penetration of the cleaning fluid into the fibers of the garment, and facilitate removal of the cleaning fluid and a stain from the garment.

The stain removal system 100 also includes a mechanical cleaning tool 116: arranged over the stage 104; and configured to mechanically agitate fibers of the garment to enhance penetration of the cleaning fluid into fibers of the garment and facilitate extraction of particles forming the stain from fibers of the garment.

The stain removal system 100 also includes a vacuum subsystem 118: fluidly coupled to the window opposite the cleaning fluid nozzle 110; and configured to suction air though the garment to remove cleaning fluid and particles forming the stain from the stained region of the garment.

The stain removal system 100 also includes a drying nozzle 114: arranged over the stage 104; and configured to direct air toward the stain removal work zone 106 to evaporate moisture from the stained region of the garment.

### 2. Method

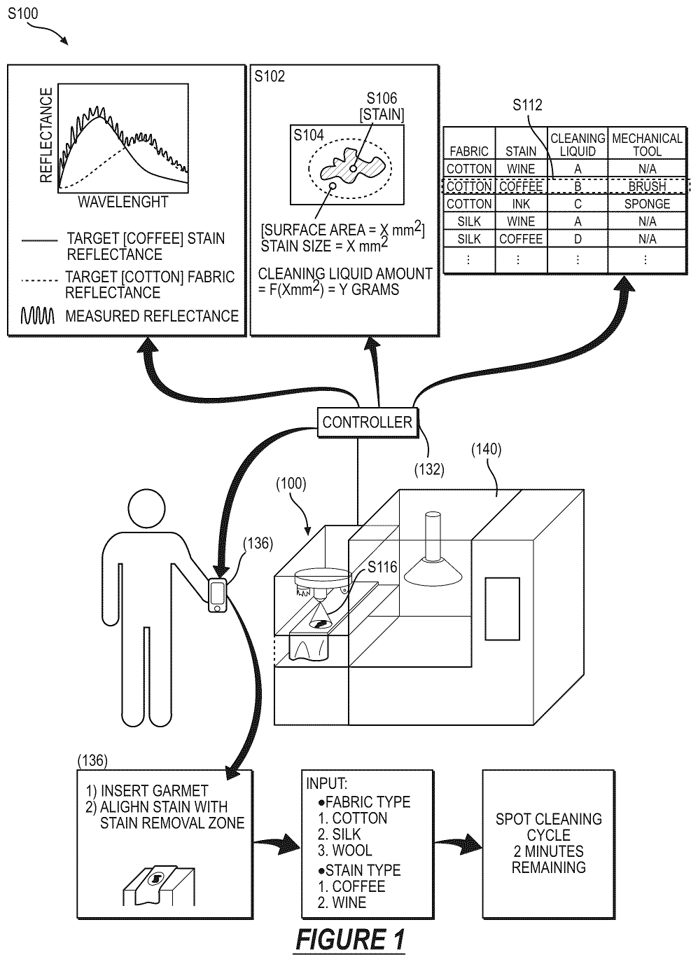

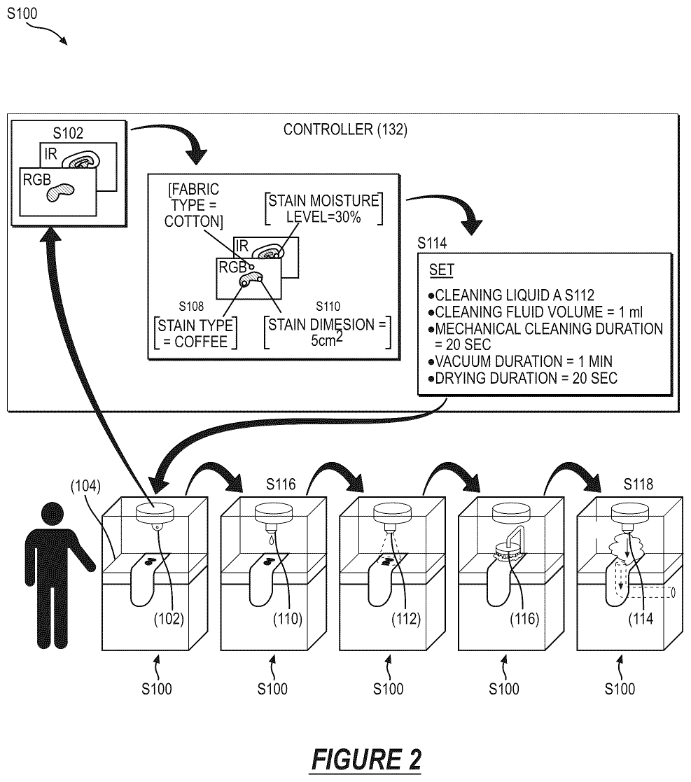

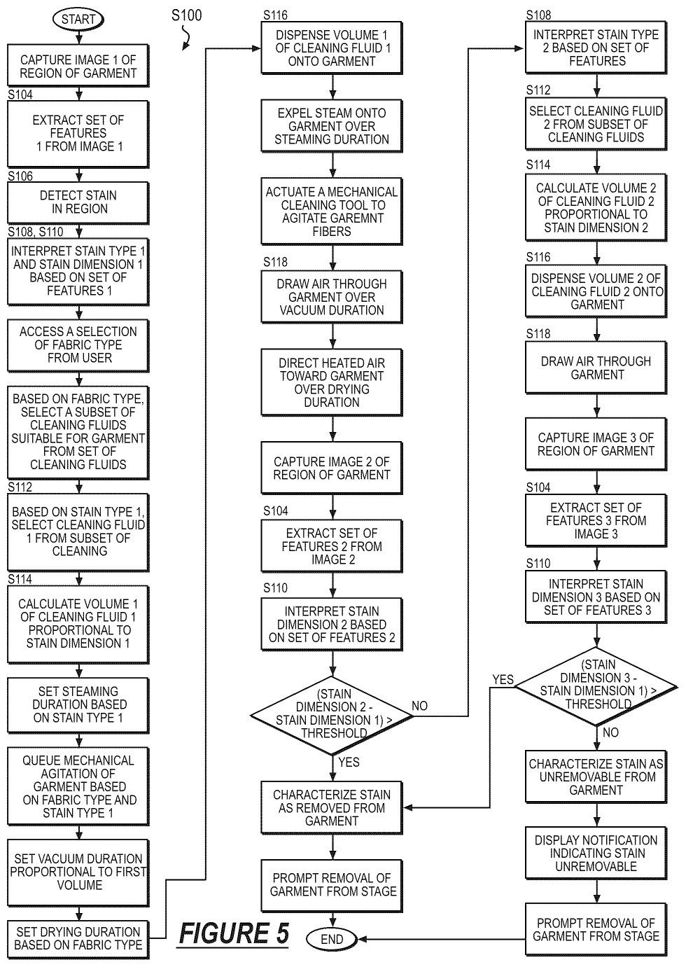

As shown in FIGS. 1, 2, and 5, a method S100 for stain removal from garments includes: accessing a first image of a first region of a first garment located on a stage 104 in Block S102; extracting a first set of features from the first image in Block S104; based on the first set of features, detecting a first stain in the first region on the first garment in Block S106 and interpreting a first stain type of the first stain in Block S108; and, based on the first stain type, selecting a first cleaning fluid, from a set of cleaning fluids, for application onto the first region of the first garment in Block S112.

The method S100 also includes, during a first stain removal cycle: dispensing a first volume of the first cleaning fluid onto the first region of the first garment adjacent the first stain via a first nozzle 110 facing the stage 104 in Block S116; and drawing air through the first region of the first garment and the stage 104 via a vacuum subsystem 118 facing the stage 104 opposite the first nozzle 110 to remove the first cleaning fluid and stain particles of the first stain from the first garment in Block S118.

### 2.1 Variation: Selecting Cleaning Fluid Volume

In one variation, the method S100 for stain removal from garments includes: accessing a first image of a first region of a first garment located on a stage 104 in Block S102; extracting a first set of features from the first image in Block S104; based on the first set of features, detecting a first stain in the first region on the first garment in Block S106 and interpreting a first dimension of the first stain in Block S110; and, based on the first dimension, selecting a first volume of a first cleaning fluid for application onto the first region of the first garment in Block S112.

The method S100 also includes, during a first stain removal cycle: dispensing the first volume of the first cleaning fluid onto the first region of the first garment adjacent the first stain via a first nozzle 110 facing the stage 104 in Block S116; and drawing air through the first region of the first garment and the stage 104 via a vacuum subsystem 118 facing the stage 104 opposite the first nozzle 110 to remove the first cleaning fluid and stain particles of the first stain from the first garment in Block S118.

### 2.2 Variation: Mechanical Agitation

In another variation, the method S100 includes: triggering an optical sensor 102 to capture an image of a stained region of a garment arranged over a stain removal work zone 106 defined by a window on a stage 104 of a stain removal system in Block S120; detecting a set of fabric features, representative of a fabric of the garment, in the image S104; and predicting a first fabric type and a first fabric thickness of the stained region of the garment based on the set of fabric features in Block S122.

This variation of the method S100 also includes: detecting a set of stain features, representative of a stain on the garment, in the image in Block S104; predicting a first stain type in Block S108 of the stain based on the set of fabric features; detecting a contour of the stain in the image in Block S124; and interpreting a first stain size of the stain based on the contour of the stain in Block S110.

This variation of the method S100 further includes, based on the first fabric type, the first fabric thickness, the first stain type, and the first stain size: selecting a first cleaning fluid, in a set of cleaning fluids, to apply to the garment in Block S112; and selecting a first cleaning fluid quantity of the first cleaning fluid to apply to the garment in Block S112.

This variation of the method S100 further includes: projecting the first cleaning fluid quantity of the first cleaning fluid onto the stained region of the garment in Block S116; triggering a mechanical cleaning tool 116, arranged over the window, to agitate the stained region of the garment in Block S126; and triggering a vacuum subsystem 118, fluidly coupled to the window, to draw a vacuum across the window and to draw the first cleaning fluid quantity of the first cleaning fluid through the first thickness of the garment and out of the garment via the window in Block S118.

### 3. Applications

Generally, as shown in FIGS. 1, 2, and 5, the method S100 can be executed by the stain removal system 100 to: receive a stained garment in the stain removal system 100; detect a fabric type and fabric thickness of a garment; and detect a stain type and a stain size of the stain on the garment. Then, the method S100 can be executed to: select custom cleaning fluid for application to the garment in order to remove the stain, the custom cleaning fluid targeted/customized for removing the stain type from the garment. More specifically, the method S100 can be executed by the controller 132 to select the custom cleaning fluid that is likely to remove a stain of the stain type without damaging a fabric of the fabric type detected. Furthermore, the method S100 can be executed by the controller 132 to, based on the stain size and the fabric thickness, select (or “calculate”) a quantity of the cleaning fluid that can remove the stain from the garment without oversaturating the garment with the cleaning fluid. In addition, the method S100 can be executed to select a mechanical cleaning mode, such as moving (e.g., brushing) a robotic arm 122 with a brush attachment across the garment repeatedly, to facilitate penetration of the cleaning fluid into the fibers of the garment and removal of the stain. Therefore, the method S100 can be executed by the controller 132 to select cleaning parameters—such as cleaning fluid type, cleaning fluid quantity, and mechanical cleaning mode—for removing the stain from the garment via the stain removal system 100 while reducing damage to the garment.

During a stain removal cycle, the stain removal system 100 can engage the cleaning fluid nozzle 110 to expel the quantity of the custom cleaning fluid onto a local area of the garment. In addition, the system can activate the mechanical cleaning tool 116, such as the brush or the sponge, to mechanically agitate the fibers of the local area of the garment by brushing or dabbing the local area. Therefore, the stain removal system 100 can execute the stain removal cycle to apply cleaning fluid to a local area on the garment and to mechanically agitate the local area on the garment to remove a stain from the local area of the garment.

Therefore, the stain removal system 100 can execute the method S100 to: identify target stain removal parameters—such as cleaning fluid type, cleaning fluid quantity, and mechanical agitation mode—for removing a particular stain from a garment of a particular fabric type and thickness; and execute the stain removal cycle to automatically remove the stain from the garment. To remove the stain, the stain removal system 100 can specifically process a local area of the garment containing a stain and avoid application of the cleaning fluid, steam, and mechanical agitation to the whole garment, thereby reducing a volume of cleaning fluid consumed per garment, reducing a duration of the cleaning cycle, and limiting wear of the garment during stain removal.

### 4. Stain Removal System

Generally, as shown in FIGS. 3 and 4, a stain removal system 100 can be configured to detect a stain on a garment and to apply cleaning fluid, steam, and/or mechanical agitation to the garment to remove the stain. In one implementation, the stain removal system 100 can be arranged proximal a dry-cleaning kiosk 140 described in the U.S. patent application Ser. No. 17/258,531. For example, prior to utilizing the dry-cleaning kiosk 140 to deodorize and remove wrinkles from the garment, a user may first insert the garment into the stain removal system 100 to remove any stains present on the garment. Alternatively, a user may first insert the garment into the stain removal system 100 to remove any stains present on the garment after utilizing the dry-cleaning kiosk 140.

### 4.1 Stage

The stain removal system 100 can include a stage 104 configured to receive the garment and retain the garment during a fabric type and stain type identification, stain removal cycle, and drying cycle.

In one implementation, the stage 104 includes a window arranged below and defining a stain removal work zone 106. In one example, the stage 104 can include a window characterized by a square window geometry and a window size corresponding to four inches by four inches. In another example, the stage 104 can include a window characterized by a circular geometry and a window size corresponding to a one inch radius. For example, a user may place the garment onto the stage 104 such that a stain on the garment is aligned with the stain removal work zone 106 and covers the window.

In addition, the window in the stage 104 can be fluidly coupled to a vacuum port configured to create a low-pressure region within or below the window in order to suction excess cleaning fluid, moisture, and/or steam from the garment through the window.

In addition, the stage 104 can include a grating or a mesh covering the window. For example, the mesh can support the garment and prevent a portion of the garment from slipping into the window. In addition, when the vacuum port is activated, the mesh can prevent a portion of the garment from being drawn into the window. More specifically, the mesh can define a set of apertures that enable the vacuum (i.e., low-pressure region within or below the window) to draw cleaning fluid and/or steam through and out of garment. For example, the window can be covered by a mesh characterized by 80% open area to ensure permeability to steam, cleaning fluid, and/or air.

### 4.2 Optical Sensor

The stain removal system 100 can include an optical sensor 102: arranged over/above the stage 104; defining a field of view directed downward toward the garment placed on the stage 104; and configured to capture an image of the garment depicting the stain. More specifically, the optical sensor 102 can define the field of view directed toward the stain removal work zone 106 on the stage 104, which is aligned with the stain on the garment.

In one implementation, the controller 132 can trigger an actuator to move an optical sensor 102 into a position directly above the stain removal work zone 106 on the stage 104. Additionally or alternatively, the optical sensor 102 can be arranged on a nosepiece 120 arranged over the stage 104.

In one implementation, the optical sensor 102 includes a multispectral optical sensor 102 configured to: capture a set of images of the garment, each image in the set of images corresponding to a segment of the electromagnetic spectrum including the ultraviolet (UV), visible, and infrared (IR) segments of the electromagnetic spectrum. For example, the multispectral optical sensor 102 can capture a first image in a first wavelength range, a second image in a second wavelength range, a third image in a third wavelength range. Additionally or alternatively, the optical sensor 102 can include a red, green, blue (hereinafter, “RGB”) optical sensor 102 configured to capture a color image of the garment. More specifically, the RGB optical sensor 102 can capture an image in a range of the electromagnetic spectrum corresponding to the red, green, and blue visible light.

### 4.3 Cleaning Fluid Nozzle

The stain removal system 100 includes a cleaning fluid nozzle 110 arranged over/above the stage 104 and configured to expel a quantity of cleaning fluid toward a surface of the garment to: apply the cleaning fluid onto the stain on the garment and facilitate removal of the stain from the garment. For example, the cleaning fluid expelled by the cleaning fluid nozzle 110 can break the chemical bonds of the particles forming the stain and/or break down chemical bonds between the particles of the stain and the fabric fibers.

In one implementation, cleaning fluid nozzle 110 includes an aerosolizing nozzle configured to expel an atomized spray of cleaning fluid particles toward a surface of the garment to evenly saturate the fibers of the garment cleaning fluid. Additionally or alternatively, the cleaning fluid nozzle 110 can include a drip nozzle configured to expel droplets of liquid cleaning fluid onto the garment.

One implementation includes a cleaning fluid storage, uptake, and mixing stain removal system 100 configured to: store a set of cleaning fluids in a set of storage tanks, each cleaning fluid formulated to dissolve a particular stain type; uptake a first quantity of a first cleaning fluid from a first storage tank in the set of storage tanks; uptake a second quantity of a second cleaning fluid from a second storage tank in the set of storage tanks; combine/mix the first quantity and the second quantity of the first cleaning fluid and the second cleaning fluid to produce a cleaning fluid mixture; and expel the cleaning fluid mixture onto the garment.

### 4.3.1 Cleaning Fluid

The stain removal system 100 includes a cleaning fluid configured to emulsify a substance forming the stain on the garment, dissolve a substance forming the stain, and/or break chemical bonds of the substance forming the stain to remove the stain from the garment.

The cleaning fluid can include a surfactant, enzyme, oxidizing agent, solvent, cleaning agent, acid or base, or a combination thereof. In one implementation, the stain removal system 100 can include a set of cleaning fluids, each cleaning fluid in the set of cleaning fluids configured to remove a particular stain type. For example, a first cleaning fluid can remove oil-based stains and a second cleaning fluid can remove coffee stains.

### 4.4 Steam Nozzle

The stain removal system 100 can include a steam nozzle 112: arranged over/above the stage 104; defining a nozzle axis directed toward the stain removal work zone 106; and configured to expel a steam jet along the nozzle axis toward a surface of the garment to tension a local area of the garment and enhance penetration of the cleaning fluid into the fibers of the garment.

In one implementation, the steam nozzle 112 is configured to expel the steam jet along the nozzle axis toward the surface of the garment to: saturate fibers of the garment with water droplets; facilitate binding of water molecules and cleaning fluid molecules to the substance forming the stain; and, thus, facilitate removal of stain from the garment.

In one implementation, the steam nozzle 112 can be configured to receive steam from a steam generator arranged within a dry-cleaning kiosk 140 described in U.S. patent application Ser. No. 17/258,531.

### 4.5 Mechanical Cleaning Tool+Agitation

In one implementation, the stain removal system 100 includes a mechanical cleaning tool 116: arranged above the stage 104; configured to mechanically agitate the fibers of the garment to enhance penetration of the cleaning fluid into the fibers of the garment; facilitate breaking of the chemical bongs of the substance forming the stain; absorb/displace the broken-down particles of the stain; and remove these particles from the garment. For example, the mechanical cleaning tool 116 can include a brush configured to sweep across the surface of the garment to remove/displace particles of the stain. In another example, the mechanical cleaning tool 116 includes a sponge configured to press against the surface of the garment to absorb particles of the stain.

In one implementation, the mechanical cleaning tool 116 can couple to a set of actuators. In this implementation, the controller 132 can trigger a first actuator to bring the mechanical cleaning tool 116 into contact with the garment arranged on the stain removal work zone 106. In this implementation, the controller 132 can also trigger a second actuator attached to the mechanical cleaning tool 116 to rotate, vibrate, and/or sweep the mechanical cleaning tool 116 across the surface of the garment to agitate the fibers of the garment.

In one implementation, the stain removal system 100 includes a set of mechanical cleaning tools 116, such as brushes, spongers, cloths, and each mechanical cleaning tool 116 in the set of mechanical cleaning tools 116 applied to remove a particular stain type and/or applied to mechanically agitate a particular fabric type.

### 4.6 Vacuum Subsystem

The stain removal system 100 can include a vacuum subsystem 118 configured to: suction air and/or steam through a local area of the garment; and suction cleaning fluid from a local area of the garment. For example, the vacuum subsystem 118 can be coupled, via the vacuum port, to the window in the stage 104 and can suction air through the window in the stage 104.

In one implementation, the vacuum subsystem 118 can include: a duct connecting 124 the vacuum port and the window in the stage 104 to a fan, the fan 128 configured to generate low pressure within the duct (e.g., within or below the window) such that air is suctioned into the vacuum port. In this implementation, the vacuum subsystem 118 can also include: an air vent arranged downstream of the fan, the air vent configured to expel air suctioned into the vacuum port; a filter 130 arranged within the duct and configured to capture particles of the substance forming the stain and/or the cleaning fluid particles; a condenser 126 arranged within the duct and configured to condense steam into water; and a water drainage system configured to capture and expel the condensed water.

### 4.7 Dryer/Air Nozzle

The stain removal system 100 can include a dryer: arranged over the stage 104; and configured to expel air toward the surface of the garment to dry the garment. In one implementation, the dryer can be configured to channel air from a heat exchanger within the dry-cleaning kiosk 140, described in the U.S. patent application Ser. No. 17/258,531, toward the garment. Thus, the dryer can dry the garment, thereby enabling a user to inspect the dry garment to determine whether the stain has been removed.

### 4.8 Cover

In one implementation, the stain removal system 100 includes a cover 108 arranged over the stage 104. In one implementation, the cover 108 can: prevent a user from coming into contact with the steam jet, the mechanical cleaning tool 116, and/or the cleaning fluid; and prevent the cleaning fluid and/or the steam from escaping into the ambient environment. In one implementation, the cover 108 can include a clear box with an open face arranged over the stage 104.

### 4.9 Tool Nosepiece

In one implementation, the stain removal system 100 can include a nosepiece 120: arranged over the stage 104; and including a rotating disk including a set of tools radially arranged on a side of the disk proximal the stage 104. In one example, the set of tools arranged on the nosepiece 120 can include an optical sensor 102 and a set of mechanical cleaning tools. In another example, the nosepiece 120 can include an optical sensor 102, a set of mechanical cleaning tools, a steam nozzle 112, and/or cleaning fluid nozzle 110 camera and a set of mechanical cleaning tools arranged radially on the disk.

In one implementation, the nosepiece 120 is attached to an actuator configured to extend or retract to move the nosepiece 120 toward or away from the stage 104. For example, the actuator can retract to bring the mechanical cleaning tool 116, mounted onto the nosepiece 120, into contact with the garment.

### 4.10 Controller

The stain removal system 100 can include a controller 132 configured to: prompt a user to place the garment onto the stage 104; trigger the optical sensor 102 to capture an image of the garment; access the image from the optical sensor 102; based on the image, detect the first fabric type, the first fabric thickness, and/or the first fabric directionality of the garment; based on the image, detect a first stain type, and/or the first stain size of the stain on the garment. Then, based on the first fabric type, the first fabric thickness, the first stain type, and/or the first stain size, the controller 132 can select: a first cleaning fluid, in a set of cleaning fluids, to apply to the garment; a first cleaning fluid quantity of the first cleaning fluid to apply to the garment; a steam duration for activation of the steam nozzle 112; a temperature of the steam expelled by the steam nozzle 112; a mechanical cleaning tool 116, in a set of mechanical cleaning tools 116, for agitation of the fibers of the garment; a force and direction for application of the mechanical cleaning tool 116; a drying duration for activation of the dryer; and a drying temperature for the air expelled by the dryer.

Furthermore, the controller 132 is configured to, during the stain removal cycle: trigger the cleaning fluid nozzle 110 to dispense the first quantity of the first cleaning fluid toward the garment; activate the steam nozzle 112 to expel the steam jet for the steaming duration; trigger the actuator to bring the mechanical cleaning tool 116 in contact with the garment; and activate the mechanical cleaning tool 116 to agitate the fibers of the garment (e.g., by brushing, dabbing, etc.). Then, during the drying cycle, the controller 132 is configured to activate the dryer to expel air toward the garment.

### 5. Prompting a User to Insert the Garment

The controller 132 is configured to prompt a user to insert the garment into the stain removal system 100 for stain removal. In one implementation, the controller 132 can prompt the user to place or hang the garment on the stage 104 such that the stain covers the window in the stage 104 and/or such that the stain is aligned with the stain removal work zone 106 on the stage 104. For example, the controller 132 can prompt the user to place the garment onto the stage 104 by displaying instructions for placing the garment onto the stage 104 on a graphical user interface 136 arranged on the stain removal system 100. Additionally or alternatively, the controller 132 can display the instructions for placing the garment onto the stage 104 on a graphical user interface 136 arranged on a side of the dry-cleaning kiosk 140.

### 6. Accessing Image of the Garment

Block S102 of the method S100 includes capturing an image of a region of a garment located on a stage 104 via an optical sensor 102 and accessing the image of the region of the garment located on the stage 104. Generally, in Block S102, the computer system can trigger the optical sensor 102 to capture the image of the garment after the garment is placed on the stage 104 and access the image of the garment from an optical sensor 102. For example, the computer system can access the image of the garment from an optical sensor 102 arranged on the interior surface—facing the stage 104—of a cover 108 configured to position over the stage 104. In this example, the computer system can trigger the optical sensor 102 to capture the image in response to user input (e.g., user selects “start” via the user interface). Therefore, the computer system can access the image of the garment in order to detect and characterize a stain on the garment.

In one example, in response to placement of a stained region of the garment over the stage 104 and subsequent closure of a cover 108 over the stage 104 and the garment, the computer system can trigger an optical sensor 102—arranged over (or under) and facing the stage 104—to capture the image of the region of the garment. For example, the optical sensor 102 can include a color (e.g., RGB) camera, infrared camera, or multispectral sensor arranged over and facing the stage 104 (opposite the vacuum subsystem 118) and defining a field of view intersecting the stage 104—and therefore the stained region of the garment located on the stage 104. Furthermore, in this example, the cover 108: is configured to shield the optical sensor 102 from ambient light; yields more consistent lighting of stained garment regions; and shields the user from cleaning fluid spray and steam jets.

In another example, the computer system can capture the image of the garment via an optical sensor 102 located below the stage 104. In this example, the stage can include a mesh or perforations that yield a high open area ratio (e.g., >70%) that enables the optical sensor 102 to capture an image of the stained region of the garment through the stage 104. Thus, in this example, in response to closure of the cover 108, the computer system can trigger the optical sensor 102—facing the stage 104 opposite the cover 108, facing a first side of the region of the garment, and defining a field of view intersecting the stage 104—to capture the image of the region of the garment through the stage 104.

### 7. Fabric Characterization: Type+Thickness+Directionality

In one implementation, the controller 132 can: prompt the user to input characteristics of the fabric of the garment, the characteristics including fabric type (e.g., cotton, wool, silk, knit fabric, woven fabric), and/or fabric thickness; and receive a user input indicating characteristics of the fabric of the garment. For example, the controller 132 can display a prompt to input the characteristics of the fabric on a touch-screen graphical user interface 136 arranged on the stain removal system 100 and receive the user input via the touch-screen graphical user interface 136. In another example, the controller 132 can display a prompt to input characteristics of the fabric of the garment via a mobile application installed on a mobile device of the user, the mobile device wirelessly communicatively coupled, via Wi-Fi or Bluetooth, to the controller 132. Then, the controller 132 can receive the user input from the mobile application, the user input provided by the user via the mobile device.

In one implementation, after the user inserts the garment, the controller 132 can: trigger the optical sensor 102 (e.g., RGB camera) to capture an image of the garment; access the image from the optical sensor 102; extract a set of fabric features of the fabric depicted in the image; and link the set of fabric features to a set of target fabric features, in a library of fabric features, the set of target fabric features associated with a first fabric type (e.g., cotton, silk, wool), in a set of fabric types, a first fabric thickness, and/or a first fabric directionality (e.g., wale direction in knit fabric, a weft direction in woven fabric), in a set of fabric directionalities. In response to linking the set of fabric features to the target set of features, the controller 132 can detect the first fabric type, the first fabric thickness, and/or the first fabric directionality of the garment. For example, the controller 132 can calculate a similarity score between the set of fabric features and each target set of fabric features in the library of fabric features. Then, in response to a calculating a highest similarity score representing similarity between the set of fabric features and the first target set of features, the controller 132 can link the set of fabric features to the first target set of features. In this implementation, the controller 132 can additionally or alternatively estimate the fabric thickness based on the detected fabric type. For example, in response to detecting that the fabric type of the garment is silk, the controller 132 can access a fabric thickness from a library of fabric thicknesses, corresponding to a typical or expected thickness of a silk fabric.

In one implementation, the controller 132 can: trigger the optical sensor 102 (e.g., multispectral optical sensor 102) to capture a set of images of the garment; access the set of images from the optical sensor 102; and, based on the set of images, construct a fabric reflectance curve for the garment, the fabric reflectance curve representing reflectance of the fabric at each wavelength detected by the multispectral optical sensor 102. Then, the controller 132 can: link the fabric reflectance curve to a target fabric reflectance curve, in a library of fabric reflectance curves, associated with the first fabric type; and, in response to linking the fabric reflectance curve to the target fabric reflectance curve, detect a first fabric type of the garment. For example, the controller 132 can: link the fabric reflectance curve to the target fabric reflectance curve by executing curve fitting techniques, such as polynomial regression or interpolation, to fit the fabric reflectance curve to each target fabric reflectance curve in the library of fabric reflectance curves; and, in response to the fabric reflectance curve and a first target fabric reflectance curve defining a “best fit,” link the fabric reflectance curve and a first target fabric reflectance curve.

### 8. Stain Characterization

The method S100 includes: extracting a set of features from the image in Block S104; based on the set of features, detecting a stain in the region on the garment in Block S106; and interpreting a stain type of the stain in Block S108.

Generally, in Block S104, the computer system can detect the stain, such as proximal a center of the image. For example, the computer system can: characterize a background color of the garment or pattern of the garment near a perimeter of the image; detect a change in a color or a pattern—from the background color or the pattern—near a center of the image; and isolate a region of the image containing this change in color pattern as the stain region.

In one implementation, the computer system can then: implement template matching to match color, size, and/or shape of the stain region to a template image of a known stain type, in a set of template images of known stain types. For example, the computer system can access the set of template images: depicting mud, coffee, mustard, and/or other stains; and labeled with stain types, stain sizes (e.g., dimensions), fabric types. In response to identifying the template image, in the set of template images, that matches the image of the stained region of the garment, the computer system can: map a stain type, a fabric type, and/or a stain size from the template image to the stained region of the garment; and set stain removal parameters—including a cleaning fluid type that removes the stain and/or that is compatible with the fabric type and/or a cleaning fluid volume applied to remove the stain—based on the stain type, the fabric type, and/or the stain size of the stain derived based on template matching.

In another implementation, the computer system can access a stain detection model trained on images of stains of known types, of known stain sizes, of fabrics of known types, etc. The computer system can pass the image of the stain region into the stain detection model, which returns a stain type and a stain size of the stain and/or a fabric type of the garment. In addition, based on the image, the stain detection model can return a cleaning fluid type(s) that removes the stain and/or that is compatible with the fabric type and/or cleaning fluid volume. Then, the computer system can set the stain removal parameters—such as steaming duration—based on the stain type, the stain type, the fabric type, the cleaning fluid type(s), and/or the cleaning fluid volume.

Therefore, the computer system can characterize the stain and the garment depicted in the image and, based on the stain and garment characteristics, set parameters the garment in order to remove the stain during the stain removal cycle.

### 8.1 Stain Dimension

In one variation, the method S100 includes detecting a stain in the region on the garment in Block S106 and interpreting a dimension of the stain in Block S110 based on the set of features extracted from the image. Generally, in Block S108, the computer system can the derive a dimension—including length, width, surface area, circumference, and color (e.g., grayscale color value, color difference from surrounding area, color gradient, color histogram)—of the stain in the image. Therefore, the computer system can detect the dimension of the stain on the garment depicted in the image, enabling the computer system to select a set of parameters—such as a cleaning fluid volume—for application to the garment in order to remove the stain.

In one implementation, the computer system can: detect a contour of the stain in the image based on the set of features extracted from the image; calculate a dimension of the stain in the image based on the contour; and translate the dimension of the stain in the image to a dimension of the stain on the garment in order to calculate the volume of the cleaning fluid based on the dimension. For example, the computer system can implement edge-detection algorithms to detect the contour of an oil-based stain on the garment and calculate a surface area of the stain in millimeters squared. Therefore, the computer system can detect the dimension of the stain based on the contour of the stain detected in the image.

### 8.2 Stain Moisture Content

In one implementation, the computer system can: trigger the optical sensor 102, such as an infrared camera, to capture an infrared image of the stained region of the garment; access the infrared image of the region of the garment located on the stage 104; and detect the stain in the region on the garment and interpret a moisture level of the stain based on the set of features extracted from the infrared image. For example, the computer system can: derive infrared reflectivity values for each pixel in the image; and interpret a moisture level of the stain region in the image, the moisture level inversely proportional to the infrared reflectivity. More specifically, the computer system can: extract a set of infrared reflectivity values of the stain region; calculate an average infrared reflectivity value based on the set of infrared reflectivity values; and calculate a moisture level for the stain region, the moisture level inversely proportional to the infrared reflectivity value. Therefore, the computer system can detect the moisture level of the stain based on the infrared absorption of the stain region of the garment.

### 8.3 Manually Entered Garment Characteristics

In one implementation, the controller 132 can: prompt a user to input characteristics of the stain on the garment, the characteristics including stain type and/or stain size; and receive a user input indicating the stain type and/or the stain size. For example, the controller 132 can: display, on a touch-screen graphical user interface 136 arranged on the side of the stain removal system 100 (or the dry-cleaning kiosk 140), a prompt to input the characteristics of the stain and receive the user input via the touch-screen graphical user interface 136. In another example, the controller 132 can display a prompt to input the stain characteristics via the mobile application installed on the mobile device of the user. Then, the controller 132 can receive the user input from the mobile application.

In one implementation, the controller 132 can: access the image of the garment from the optical sensor 102 (e.g., RGB camera); extract a set of stain features of the stain depicted in the image; and link the set of stain features to a target set of stain features, in a library of stain features, associated with a first stain type (e.g., coffee, wine, grass, cosmetics), in a set of stain types. In response to linking the set of stain features to the target set of stain features, the controller 132 can detect the first stain type of the stain on the garment.

In one implementation, the controller 132 can: access the image of the garment from the optical sensor 102 (e.g., multispectral optical sensor 102); based on the image, construct a stain reflectance curve for the stain, the reflectance curve representing reflectance of the stain at each wavelength detected by the multispectral optical sensor 102; link the reflectance curve to a target stain reflectance curve associated with the first stain type; and, in response to linking the reflectance curve to the target reflectance curve, detect a first fabric type of the garment.

More specifically, the controller 132 can: based on the image, construct a combined reflectance curve, the combined reflectance curve representing reflectance of the fabric and the stain at each wavelength detected by the multispectral optical sensor 102; link the combined reflectance curve to the target fabric reflectance curve, in the library of target fabric reflectance curves; extract a fabric reflectance curve from the combined reflectance curve by isolating a portion of the combined reflectance curve fitting the target fabric reflectance curve; extract a stain reflectance curve by calculating a difference between the combined reflectance curve and the fabric reflectance curve; and link the stain reflectance curve to a target stain reflectance curve, in the library of target stain reflectance curves. In response to linking the combined reflectance curve to the target fabric reflectance curve, the controller 132 can detect the first fabric type associated with the target fabric reflectance curve. In response to linking the stain reflectance curve to the target stain reflectance curve, the controller 132 can detect the first stain type associated with the target stain reflectance curve.

In one implementation, controller 132 can: execute various edge detection techniques (e.g., Canny edge detector, Sobel operator, Prewitt Operator) to identify a contour of the stain in the image captured by the optical sensor 102 or in an image, in the set of images, captured by the multispectral optical sensor 102; and, based on the contour of the stain, detect stain size. For example, the controller 132 can calculate an area within the contour and store the area as the stain size.

### 9. Parameter Selection for Stain Removal Cycle

Generally, based on a set of stain characteristics—such as stain type, stain dimension, and stain moisture level—and a set of garment characteristics—such as fabric type and fabric thickness—the computer system can derive a set of parameters for the stain removal cycle to enable stain removal from the garment during the stain removal cycle. The computer system can select the set of parameters including cleaning fluid type, cleaning fluid volume, steaming duration, mechanical cleaning duration, vacuum duration, and drying duration.

### 9.1 Cleaning Fluid Parameter Selection

Block S112 of the method S100 recites selecting a cleaning fluid, from a set of cleaning fluids, for application onto the region of the garment based on the stain type. Generally, in Block S112, the computer system can select a stain-specific cleaning fluid for application onto the garment in order to remove the stain. For example, the computer system can select an enzyme-based cleaning fluid (e.g., amylase-based cleaner) for application on a wine-stained garment. Therefore, the computer system can select a cleaning fluid tailored to the specific stain type, thereby enabling stain removal from the garment while preserving garment integrity.

In one variation, Block S112 of the method S100 recites selecting a volume of a cleaning fluid for application onto the region of the garment. In this variation, in Block S112, the computer system can select a stain-specific volume of cleaning fluid for application onto the garment in order to remove the stain. For example, the computer system can select a volume of cleaning fluid—corresponding to 1 milliliter—proportional to the stain dimension. Therefore, the computer system can select a cleaning fluid volume corresponding to the stain dimension, thereby enabling stain removal from the garment while preserving garment integrity, avoiding applying excess cleaning fluid onto the garment, and minimizing stain removal cycle duration (e.g., by reducing vacuum duration for removing the cleaning fluid from the garment).

In one implementation, the controller 132 can: select a first cleaning fluid, in a set of cleaning fluids, based on the stain type of the stain and/or the fabric type of the garment; and select a first quantity of cleaning fluid based on the stain size of the stain, the fabric type, and/or the fabric thickness of the garment. For example, in response to detecting a first stain type of the stain, the controller 132 can identify, in a library of cleaning fluids, a first cleaning fluid type (e.g., acid-based cleaning fluid), corresponding to the first cleaning fluid in the stain removal system 100, for removing the first stain type (e.g., mineral residue-based stain). In another example, in response to detecting a first stain type of the stain and a first fabric type of the garment, the controller 132 can select a first cleaning fluid formulation. However, in response to detecting the first stain type of the stain and a second fabric type of the garment, the controller 132 can select a second cleaning fluid formulation.

In another implementation, the computer system can: select a subset of cleaning fluids—from a set of cleaning fluids available within the system 100—compatible with a fabric type of a garment; and select a cleaning fluid—from the subset of cleaning fluids—that is both compatible with the fabric type of the garment and configured to remove the stain type. More specifically, for a first garment of a first fabric type and with a first stain of a first stain type, the computer system can: identify a first subset of cleaning fluids, from the set of cleaning fluids, compatible with the first fabric type based on the first fabric type; and select a first cleaning fluid for application onto the garment, from the first subset of cleaning fluids, based on the first stain type. In this implementation, for a second garment of a second fabric type and with a second stain of a second stain type, the computer system can: identify a second subset of cleaning fluids—different from the first subset of cleaning fluids—from the set of cleaning fluids, compatible with the second fabric type based on the second fabric type; and based, on the second stain type, select a cleaning fluid, from the subset of cleaning fluids, for application onto the region of the garment.

Therefore, the computer system can select cleaning fluids that are both fabric—safe and stain—specific, enabling stain removal for diverse garment types while preserving the integrity of the fabric.

### 9.2 Complex Stain

In one implementation, in response to detecting a stain including a blend of a more than one stain types, the controller 132 can select a cleaning fluid including a mixture of more than one cleaning fluid. For example, in response to detecting a stain characterized by a first stain type (e.g., oil) and a second stain type (e.g., ink), the controller 132 can select a cleaning fluid including a first cleaning fluid (e.g., cleaning fluid for oil-based stains) and a second cleaning fluid (e.g., cleaning fluid for ink-based stains).

### 9.3 Blended Fabric

In one implementation, in response to detecting a fabric type of the garment that includes a blend of several fabric types, the controller 132 can: select multiple (e.g., a combination of) cleaning fluids to apply to the stained region of the garment; and calculate a volume of each cleaning fluid, such as based on proportions of fabric types in the garment and stain extraction efficacy of the cleaning fluids for these fabric types. Furthermore, for each cleaning fluid in the mixture of cleaning fluids, the controller 132 can determine a fraction (i.e., percentage) of the cleaning fluid, proportional to a percentage of a corresponding fabric type in the garment. For example, in response to detecting that a fabric type including a fabric blend of 50% cotton and 50% polyester, the controller 132 can select a cleaning fluid including 50% cleaning fluid for cotton and 50% cleaning fluid for polyester.

### 9.4 Steam Parameter Selection: Steam Duration+Temperature

In one implementation, the controller 132 can, based on the fabric type, the fabric thickness, stain type, and/or the stain moisture level select a steaming duration and/or steam temperature of the steam expelled onto the garment. For example, in response to detecting that the fabric type of the garment is silk—which is delicate and may be damaged by higher-temperature and/or high-pressure steam—the controller 132 can select a low steam temperature. In another example, in response to detecting that the fabric thickness exceeds a thickness threshold (i.e., the fabric of the garment is thick), the controller 132 can select a relatively long steaming duration.

In one implementation, the computer system can select the steaming duration based on the fabric type of the garment. More specifically, the computer system can detect that the garment is composed of silk and, based on this fabric type, select a steaming duration falling below a threshold steaming duration to prevent damage to the garment while dissolving the stain. Therefore, the computer system can tailor steaming durations to the specific fabric types, ensuring stain removal while preserving the integrity of the fabric.

In another implementation, the computer system can select a steaming duration based on a moisture level of the stain, the steaming duration inversely proportional to the moisture level of the stain. More specifically, in response to detecting a first moisture level of the stain—the first moisture level falling below a moisture level threshold—indicating that the stain has been present on the garment for over two weeks, the computer system can set a first steaming duration—exceeding a threshold steaming duration—in order to enable moisture from the steam jet to penetrate the stain and begin to dissolve the stain. Therefore, the computer system can set the steaming duration proportional the moisture level of the stain to enable the system 100 to treat difficult-to-remove stains, such as stains characterized by low moisture levels.

### 9.5 Mechanical Cleaning Parameter Selection: Tool+Pressure+Direction

In one implementation, based on the stain type and/or the fabric type, the controller 132 can select a mechanical cleaning tool 116 (e.g., brush, sponge), in a set of mechanical cleaning tools 116, for application to the garment. Furthermore, based on the stain type and/or the fabric type, the controller 132 can select direction and pressure for application of the mechanical cleaning tool 116. For example, in response to detecting a first stain type (e.g., ink), the controller 132 can select a first mechanical cleaning tool 116 (e.g., sponge), in the set of mechanical cleaning tools 116. In another example, in response to detecting fabric type including knit fabric, the controller 132 can select a mechanical cleaning mode including brushing the fabric in the wale direction of the fabric. In yet another example, in response to detecting a delicate fabric type, such as silk, the controller 132 can select a relatively low pressure (i.e., force) of application of the mechanical cleaning tool 116. However, in response to detecting a durable fabric type, such as nylon, the controller 132 can select a relatively high pressure of application of the mechanical cleaning tool 116.

### 9.6 Vacuum Parameter Selection: Vacuum Pressure+Drying

In one implementation, based on the fabric type, the stain type, the cleaning fluid type, the cleaning fluid quantity, and/or the steam duration, the controller 132 can select a suction pressure vacuum subsystem 118. In one example, in response to detecting a delicate fabric type, such as silk, the controller 132 can select a relatively low suction pressure in order to reduce risk (or magnitude) of damage to the garment. In another example, in response to the cleaning fluid quantity exceeding a threshold quantity, the controller 132 can select a relatively high suction pressure in order to suction the cleaning fluid quantity from the garment.

In one implementation, based on the fabric type, the cleaning fluid quantity, and/or the steam duration, the controller 132 can select a drying temperature of the air expelled by the dryer and/or drying duration of a drying cycle. For example, in response to detecting a fabric thickness exceeding a threshold thickness, the controller 132 can select a relatively long drying duration. In another example, in response to setting a steam duration exceeding a threshold duration, the controller 132 can select a relatively long drying duration in order to dry the garment, which may restore the original (i.e., dry) color and texture of the garment, thereby enabling the user to verify whether the stain has been removed.

### 10. Stain Removal Cycle

During a stain removal cycle, the stain removal system 100 can: engage the cleaning fluid nozzle 110 to expel the first quantity of the first cleaning fluid onto the garment, the first cleaning fluid and the first quantity selected by the controller 132; during the steaming duration, activate the steam nozzle 112 to expel the steam jet toward the garment, the steam characterized by the steam temperature selected by the controller 132; and activate the fan 128 of the vacuum subsystem 118 to generate suction at the suction pressure selected by the controller 132. Furthermore, the system can activate the mechanical cleaning tool 116 to mechanically agitate the fibers of the garment by brushing or dabbing the garment at the pressure (i.e., force) selected by the controller 132.

Therefore, the stain removal system 100 can execute the stain removal cycle to apply cleaning fluid, steam, and/or suction to the garment to remove a stain from the garment.

### 10.1 Cleaning Fluid Application

Block S116 of the method S100 recites dispensing the volume of the cleaning fluid onto the region of the garment adjacent the stain via a first nozzle 110 (e.g., cleaning fluid dispensing nozzle) facing the stage 104 during the stain removal cycle. Generally, in Block S116, the computer system can trigger the first nozzle 110 to dispense the volume of the cleaning fluid onto the garment according to the cleaning fluid application parameters—such as cleaning fluid type and cleaning fluid volume—selected based on the set of characteristics of the stain derived based on image. For example, the computer system can trigger the first nozzle 110 to dispense 1 mL of enzyme-based cleaning fluid onto a wine stain on the garment. Therefore, the computer system can trigger application of a precise volume of a stain-specific cleaning fluid onto the garment to: enhance stain removal; avoid applying excess cleaning fluid onto the garment; and minimize duration of the stain removal cycle (by reducing time duration to remove the cleaning fluid from the garment).

In one implementation, the computer system can dispense various stain-specific cleaning fluids from nozzles connected to cleaning fluid reservoirs. More specifically, the computer system can pump a first volume of a first cleaning fluid from a reservoir containing the first cleaning fluid to a first nozzle 110 to dispense the first volume of the first cleaning fluid onto a first stain of a first garment. In this implementation, the computer system can also pump a second volume of a second cleaning fluid onto a second stain on a second garment via a second nozzle 112 facing the stage 104, adjacent the first nozzle 110, and coupled to a second reservoir containing the second cleaning fluid. For example, the computer system can: pump 1 mL of an enzyme-based cleaning fluid onto a first garment to break down a food-based stain; and then pump 0.5 mL of an oxidizing cleaning fluid onto a second garment with a wine stain to neutralize pigmentation. Therefore, by dispending stain-specific cleaning fluids from separate nozzles connected to separate reservoirs, the computer system can prevent cross-contamination and ensure stability of cleaning fluids. Furthermore, the computer system can enable addition of new cleaning fluids to the system 100 for substitution of existing cleaning fluids with new cleaning fluids in the system.

Additionally or alternatively, the computer system can pump the first cleaning fluid from the first nozzle 110 and the second cleaning fluid from the second nozzle 112 in sequence onto the first garment. For example, the computer system can pump a first volume of an enzyme-based cleaning fluid onto the first garment to break down organic material and then pump a second volume of an oxidizing cleaning fluid onto the first garment to neutralize residual pigments and brighten the fabric. Therefore, by dispending stain-specific cleaning fluids from separate nozzles connected to separate reservoirs, the computer system enables sequential treatment of a garment with more than one cleaning fluid to treat composite or difficult-to-remove stains.

### 10.2 Steaming

In one implementation, during a stain removal cycle, the computer system can trigger a second nozzle 112 (i.e., a steam nozzle 112) to direct a jet of steam toward the region of a garment adjacent a stain over a steaming duration to enhance penetration for a cleaning fluid into fibers of the garment and enhance extraction of the stain from the garment. For example, the computer system can direct the second nozzle 112—arranged above the stage 104, such as on the cover 108—to expel the jet of steam toward the region of the garment following application of cleaning fluid onto the region of the garment. Additionally or alternatively, the computer system can direct the second nozzle 112 to expel the jet of steam toward the region of the garment prior to application of the cleaning fluid onto the garment. Therefore, the computer system can direct the second nozzle 112 to expel steam toward the region of the garment to saturate the region of the garment with moisture, saturate the stain with moisture, enhance penetration of cleaning fluid into the fibers of the garment and the stain, and dissolve (parts of) the stain, thereby enabling removal of the stain from the garment.

### 10.3 Mechanical Agitation of Garment

In one implementation, during the stain removal cycle, the computer system can trigger an actuator to articulate a mechanical cleaning tool 116 across the region of the garment to mechanically agitate fibers of the garment over the mechanical agitation duration to enhance penetration of the cleaning fluid and of water into fibers of the garment and enhance extraction of the stain from the garment.

In one example, the computer system can trigger an actuator to articulate a mechanical cleaning tool 116—such as a brush—along a path across the region of the garment adjacent the stain. The mechanical cleaning tool 116 can drive the cleaning fluid into the fabric fibers, aerate the cleaning fluid to generate foam, and agitate (or scrape, brush) stain particles off of or to the surface of the garment.

In another example, the computer system can trigger an actuator to articulate a mechanical cleaning tool 116—such as a sponge—to intermittently contact the region of the garment adjacent the stain to enable targeted penetration of the cleaning fluid and moisture into the fabric fibers, facilitate the removal of stain particles, and prevent the spreading of the stain to adjacent areas of the garment.

In the foregoing examples, the mechanical cleaning tool 116 can include a boom (e.g., an adjustable mechanical arm) and a brush (or another applicator, such as a sponge) arranged on a distal end of the boom. The mechanical cleaning tool 116 can also include vertical and horizonal actuators configured to drive the boom downward into contact with the garment and across the stain region of the garment while the brush rotates or oscillates.

### 10.4 Cleaning Fluid and Moisture Removal

Block S118 of the method S100 recites, during the stain removal cycle, drawing air through the region of the garment and the stage 104—via a vacuum subsystem 118 facing the stage 104 opposite the nozzle—to remove the cleaning fluid and stain particles of the stain from the garment. Generally, in Block S118, the computer system can actuate the vacuum subsystem 118 to draw (i.e., suction) air through the region of the garment adjacent the stain and the stage 104—over a vacuum duration—to remove the cleaning fluid, moisture, and stain particles from the garment. For example, after completion of the steaming duration, the computer system can activate a fan, arranged within a duct connected to a vacuum port and a perforation in the stage 104, to generate low pressure within the duct and draw air downward through the garment, the perforation in the stage 104, the vacuum port, and the duct before expelling the air. Therefore, the computer system can trigger a vacuum subsystem 118 to draw air through the garment to remove cleaning fluid from the garment, remove moisture from the garment, and remove stain particles from the garment, thereby removing the stain from the garment, preventing formation of stain or cleaning fluid residue on the garment, and restoring the garment to a wearable condition.

### 10.4.1 Stain Extraction with Stain on First Side of Garment

In one example, the computer system triggers the vacuum subsystem 118 to draw air downward through a garment arranged on a stage 104 with the stain facing the cover 108 arranged over the stage 104. In this implementation, the computer system can: detect the stain in a region on a first side of the garment, the first side facing the cover 108; dispense the volume of the cleaning fluid onto the region on the first side of the garment. Accordingly, the computer system can: detect a stain on the first side of the garment facing the cover 108; and dispense the cleaning fluid directly onto the first side of the garment and the stain via the first nozzle 110 arranged on the cover 108.

In this example, the computer system can trigger the vacuum subsystem 118 to draw air through the region (e.g., region proximal the stain) of the garment and the stage 104 to draw the cleaning fluid and stain particles of the stain: from the first side of the garment, through the garment, to a second side of the garment opposite the first side of the garment; and through the stage 104 (e.g., via a perforation coupled to a vacuum port). Therefore, the computer system can trigger the first nozzle 110 to dispense the volume of the cleaning fluid directly onto the stain and the first side of the garment to enable the cleaning fluid to penetrate the stain.

### 10.4.2 Stain Extraction with Stain on Second Side of Garment

In one example, the computer system triggers the vacuum subsystem 118 to draw air downward through a garment arranged on a stage 104 with the stain facing the stage 104. In this implementation, the computer system can: detect the stain in the region on the second side of the garment; and dispense the volume of the cleaning fluid onto the first side—opposite the second side—of the garment proximal the stain via the nozzle arranged on the cover 108. Accordingly, the computer system can: detect a stain on the second side of the garment facing the stage 104; and dispense the cleaning fluid onto the first side of the garment—opposite the stain—via the first nozzle 110 arranged on the cover 108.

In this example, the computer system can trigger the vacuum subsystem 118 to draw air through the region of the garment to: draw the cleaning fluid from the first side of the garment, through the garment, to the second side of the garment; draw the cleaning fluid and stain particles of the stain off of the second side of the garment; and draw the cleaning fluid and stain particles of the stain through the stage 104 (e.g., via a perforation coupled to a vacuum port). Therefore, the computer system can trigger the first nozzle 110 to dispense the volume of the cleaning fluid onto a side of the garment opposite the stain and suction the cleaning fluid through the garment to enable the cleaning fluid to reach stain particles embedded deep within the garment fibers. Furthermore, by drawing the stain particles off the second side of the garment rather than through the garment, the computer system can enable thorough stain extraction by avoiding pulling of stain particles deep into the garment fibers.

### 10.5 Drying

In one implementation, during the stain removal cycle, the computer system can direct a third nozzle 114 to expel air (e.g., ambient air, heated air) toward the region of the garment adjacent the stain over the drying duration to evaporate moisture from the region of the garment. For example, the computer system can direct the third nozzle 114—arranged over the stage 104, such as on a cover 108—to direct heated air toward the garment over the drying duration proportional to the steaming duration and/or to the thickness of the garment. Therefore, the computer system can evaporate moisture from the garment to return the garment to an original state (e.g., dry-state color, texture) to enable the computer system and/or the user to verify that the stain has been removed. Furthermore, the computer system can evaporate the moisture from the garment to prepare the garment for use and/or further processing.

During a drying time period of the stain removal cycle (or the drying cycle), the stain removal system 100 can: activate the dryer to expel air toward the garment, the air characterized by the drying temperature set by the controller 132. Therefore, the stain removal system 100 can execute the drying cycle to dry the garment and prepare the garment to be worn by the user or processed by the dry-cleaning kiosk 140. Then, the user may then collect the garment from the stain removal system 100.

A user may utilize the spot removal system 100 and the dry cleaning kiosk 140 to remove stains from, deodorize, and remove wrinkles from the garment. For example, prior to utilizing the dry-cleaning kiosk 140 to deodorize and remove wrinkles from the garment, a user may first insert the garment into the stain removal system 100 to remove any stains present on the garment. In this implementation, the controller 132 can receive a user input, via the graphical user interface 136, indicating that the user intends to insert the garment in the dry-cleaning kiosk 140 following the spot-cleaning cycle. In this implementation, the controller 132 can execute a partial drying cycle to partially dry the garment to reduce drying time, as the garment will be steam-treated and fully dried by dry-cleaning kiosk 140.

### 11. Closed-Loop Controls

In one implementation, after executing the first stain removal cycle and a first drying cycle, the controller 132 can verify that the stain has been removed from the garment. If the stain is removed, the controller 132 can prompt the user to collect the garment from the stain removal system 100.

### 11.1 Verifying Stain Absence

In one implementation, the computer system can verify absence of the stain from the garment after completion of the stain removal cycle based on a second image of the garment captured in response to completion of the stain removal cycle. More specifically, prior to completion of the stain removal cycle, the computer system can calculate a first dimension of the stain based on a first image of the region (e.g., region containing the stain) of the garment. In response to completion of the stain removal cycle, the computer system can: access a second image of the region of the garment located on the stage 104; extract a set of features from the second image; and, based on the set of features, calculate a second dimension (e.g., size) of the stain following the stain removal cycle. Accordingly, the computer system can re-characterize a dimension of the stain on the garment following the stain removal cycle to verify removal of the stain from the garment.

The computer system can then: calculate a difference between a first dimension of the stain calculated prior to the stain removal cycle and the dimension; and, in response to the difference exceeding a threshold difference, characterize the stain as removed from the garment and prompt removal of the garment from the stage 104. Accordingly, in response to the difference in dimension of the stain prior to and after the stain removal cycle exceeding a threshold—indicating a significant reduction in stain dimension—the computer system can characterize the stain as removed from the garment and prompt the user to collect the garment from the stage 104.

Alternatively, the computer system can characterize the stain as removed in response to the second stain dimension falling below a threshold stain dimension, indicating that the stain is not visible on the garment.

Therefore, after completion of the stain removal cycle and prior to collection of the garment by the user, the computer system can verify removal of the stain from the garment to ensure user satisfaction.

### 11.2 Detecting Stain Presence after Stain Removal Cycle

In one implementation, in response to detecting presence of the stain on the garment following the stain removal cycle, the controller 132 can repeat the stain removal cycle. More specifically, in response to detecting completion of the drying cycle, the controller 132 can: trigger the optical sensor 102 (e.g., RGB camera) to capture a second image; and detect a presence or an absence of the stain in the second image. For example, the controller 132 can: detect a second set of stain features, representative of the stain on the garment, in the second image; based on the second set of stain features, link the stain to a previously-detected stain (e.g., detected in the first image captured at a preceding time); detect a second contour of the stain; and interpret a second stain size of the stain based on the contour. In response to the stain size falling below the threshold stain size, or in response to failing to link the stain to a previously-detected stain based on the second set of stain features, the controller 132 can detect an absence of the stain.

In response to the stain size exceeding a threshold stain size, the controller 132 can: detect a presence of the stain; and select a second cleaning fluid quantity and a second cleaning fluid in the set of cleaning fluids to apply to the garment during the second stain removal cycle. For example, the controller 132 can: select a second cleaning fluid quantity exceeding the first cleaning fluid quantity applied to the garment during the first stain removal cycle; and select a different cleaning fluid that is more potent (or more concentrated) than the first cleaning fluid applied during the first stain removal cycle. Then, the controller 132 can execute a second stain removal cycle and apply the second quantity of the second cleaning fluid to the garment. The controller 132 can repeat the process of detecting the stain, selecting the cleaning fluid quantity and/or the cleaning fluid type, and repeating the stain removal cycle as long as the stain remains on the garment.

For example, the computer system can detect presence of the stain on the garment after completion of the stain removal cycle based on a second image of the garment captured in response to completion of the stain removal cycle. More specifically, the computer system can execute methods and techniques described herein to: calculate a first dimension (e.g., first surface area) of the stain on the garment at a first time preceding the stain removal cycle; and calculate a second dimension (e.g., second surface area) of the stain on the garment at a second time succeeding the stain removal cycle.

After completion of the stain removal cycle, the computer system can also: calculate a difference between a first dimension and the second dimension; and, in response to the difference falling below the threshold difference, characterize the stain as remaining on the region of the garment. Then, based on the set of features extracted from the second image captured in response to completion of the stain removal cycle, interpret a stain type of the stain; based on the stain type, select a second cleaning fluid for application onto the garment; and initiate a second stain removal cycle.

Accordingly, in response to the difference in dimension of the stain prior to and after the stain removal cycle falling below the threshold difference—indicating a significant reduction in stain dimension—the computer system can characterize the remaining stain on the garment, which may indicate a stain type detection error or a cleaning fluid selection error prior to the stain removal cycle. Accordingly, the computer system can re-characterize the stain type based on the second image, select an appropriate secondary cleaning fluid, and initiate an additional stain removal cycle to ensure stain removal.

During the second stain removal cycle, the computer system can dispense a second volume of the second cleaning fluid onto the region of the garment adjacent the stain and draw air through the region of the garment and the stage 104 to remove the cleaning fluid and stain particles of the stain from the garment.

### 11.3 Unremovable Stain

In one example, in response to completion of the second stain removal cycle, the computer system can: access a third image of the region of the garment located on the stage 104; extract a third set of features from the third image; and, based on the third set of features, calculate a third dimension of the stain following the second stain removal cycle. Accordingly, the computer system can re-characterize a dimension of the stain on the garment following the second stain removal cycle to verify removal of the stain from the garment.

After completion of the second stain removal cycle, the computer system can also: calculate a second difference between the first dimension of the stain detected prior to the first stain removal cycle and the third dimension of the stain; and, in response to the second difference falling below the threshold difference, flag the stain as unremovable from the region of the garment.

Therefore, the computer system can evaluate progress of stain removal by comparing stain dimensions across multiple cleaning cycles, enabling precise determination of stain removal effectiveness, or flagging persistent stains as unremovable, thereby minimizing unnecessary resource expenditure by the system 100.

### 11.4 Updating Stain Removal Cycle Parameters

In one implementation, in response to detecting the stain on the garment after the first cleaning cycle, the controller 132 can update a model or a database specifying stain removal parameters (e.g., cleaning fluid quantity, the cleaning fluid type, steam temperature, steaming duration, suction pressure) for each combination of stain and garment characteristics (e.g., stain type, stain size, fabric type, and fabric thickness). For example, in response to detecting absence of a first stain type from the garment following application of a first cleaning fluid and detecting presence of the first stain type on the garment following application of the second cleaning fluid, the computer system can update the model or the database by linking the first stain type with the first cleaning fluid. Therefore, the controller 132 can learn parameter combinations associated with successful removal of the stain from the garment, thereby continuously improving the model.

### 12. Other Stained Regions

In one implementation, the controller 132 can detect an additional (e.g., second) stained region based on the image captured by the optical sensor 102. In this implementation, in response to detecting the additional stained region, the controller 132 can execute the methods and techniques described herein to: select a second cleaning fluid and the second cleaning fluid quantity for application onto the additional stained region; select other stain removal cycle parameters (e.g., steaming duration, vacuum duration) for a second stain removal cycle for the additional stained region; and execute a second stain removal cycle for the additional stained region.

### 13. Conclusion

The systems and methods described herein can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of a user computer or mobile device, wristband, smartphone, or any suitable combination thereof. Other systems and methods of the embodiment can be embodied and/or implemented at least in part as a machine configured to receive a computer-readable medium storing computer-readable instructions. The instructions can be executed by computer-executable components integrated by computer-executable components integrated with apparatuses and networks of the type described above. The computer-readable medium can be stored on any suitable computer-readable media such as RAMs, ROMs, flash memory, EEPROMs, optical devices (CD or DVD), hard drives, floppy drives, or any suitable device. The computer-executable component can be a processor but any suitable dedicated hardware device can (alternatively or additionally) execute the instructions.

As a person skilled in the art will recognize from the previous detailed description and from the figures and claims, modifications and changes can be made to the embodiments of the invention without departing from the scope of this invention as defined in the following claims.

I claim:

1. A method comprising:
accessing a first image of a first region of a first garment located on a stage;
extracting a first set of features from the first image;
based on the first set of features:
detecting a first stain in the first region on the first garment; and
interpreting a first stain type of the first stain;
based on the first stain type, selecting a first cleaning fluid, from a set of cleaning fluids, for application onto the first region of the first garment; and
during a first stain removal cycle:
via a first nozzle facing the stage, dispensing a first volume of the first cleaning fluid onto the first region of the first garment adjacent the first stain; and
o via a vacuum subsystem facing the stage opposite the first nozzle, drawing air through the first region of the first garment and the stage to remove the first cleaning fluid and stain particles of the first stain from the first garment.

2. The method of claim 1, further comprising:
based on the first set of features, detecting a fabric type of the first garment;
based on the fabric type and the first stain type, selecting a steaming duration for the first garment; and
during the first stain removal cycle:
via a second nozzle, directing a jet of steam toward the first region of the first garment over the steaming duration to:
enhance penetration of the first cleaning fluid into fibers of the first garment; and
enhance extraction of the first stain from the first garment.

3. The method of claim 1, further comprising:
receiving selection of a fabric type of the first garment from a user via a user interface arranged proximal the stage;
based on the fabric type and the first stain type, queuing mechanical agitation of the first region during the first stain removal cycle; and
during the first stain removal cycle:
triggering an actuator to articulate a mechanical cleaning tool across the first region of the first garment to:
mechanically agitate fibers of the first garment; and
enhance penetration of the first cleaning fluid into fibers of the first garment.

4. The method of claim 1, further comprising:
detecting a contour of the first stain in the first region of a first garment based on the first set of features;
calculating a first dimension of the first stain in the first image based on the contour; and
calculating the first volume of the first cleaning fluid proportional to the first dimension.

5. The method of claim 1, further comprising:
based on the first set of features, calculating a first dimension of the first stain prior to the first stain removal cycle; and
in response to completion of the first stain removal cycle:
accessing a second image of the first region of the first garment located on the stage;
extracting a second set of features from the second image;
based on the second set of features, calculating a second dimension of the first stain following the first stain removal cycle;
calculating a difference between the first dimension and the second dimension; and
in response to the difference exceeding a threshold difference:
characterizing the first stain as removed from the first garment; and
prompting removal of the first garment from the stage.

6. The method of claim 1, further comprising:
based on the first set of features, calculating a first dimension of the first stain prior to the first stain removal cycle; and
in response to completion of the first stain removal cycle:
accessing a second image of the first region of the first garment located on the stage;
extracting a second set of features from the second image;
based on the second set of features:
detecting the first stain in the first region on the first garment; and
calculating a second dimension of the first stain following the first stain removal cycle;
calculating a difference between the first dimension and the second dimension; and
in response to the difference falling below a threshold difference:
characterizing the first stain as remaining on the first region of the first garment;
based on the second set of features, interpreting a second stain type of the first stain;
based on the second stain type, selecting a second cleaning fluid, from the set of cleaning fluids, for application onto the first garment, the second cleaning fluid different from the first cleaning fluid; and
during a second stain removal cycle succeeding the first stain removal cycle:
dispensing a second volume of the second cleaning fluid onto the first region of the first garment adjacent the first stain; and
drawing air through the first region of the first garment and the stage to remove the second cleaning fluid and stain particles of the first stain from the first garment.

7. The method of claim 6, further comprising, in response to completion of the second stain removal cycle:
accessing a third image of the first region of the first garment located on the stage;
extracting a third set of features from the third image;
based on the third set of features, calculating a third dimension of the first stain following the second stain removal cycle;
calculating a second difference between the first dimension and the third dimension;
and
in response to the second difference falling below the threshold difference, flagging the first stain as unremovable from the first region of the first garment.

8. The method of claim 1:
further comprising:
receiving selection of a first fabric type of the first garment from a user via a user interface arranged proximal the stage; and
based on the first fabric type, identifying a first subset of cleaning fluids, in the set of cleaning fluids compatible with the first fabric type;
wherein selecting the first cleaning fluid for application onto the first garment comprises selecting the first cleaning fluid, from the first subset of cleaning fluids, for application onto the first garment based on the fabric type; and
wherein dispensing the first volume of the first cleaning fluid onto the first region of the first garment comprises pumping the first volume of the first cleaning fluid from a first reservoir containing the first cleaning fluid to the first nozzle.

9. The method of claim 8, further comprising:
accessing a second image of a second region of a second garment located on the stage at a second time succeeding the first stain removal cycle;
extracting a second set of features from the second image;
based on the second set of features:
detecting a second stain in the second region on the second garment; and
interpreting a second stain type of the second stain, the second stain type different from the first stain type;
receiving selection of a second fabric type of the second garment from a second user via the user interface, the second fabric type different from the first fabric type;
based on the second fabric type, identifying a second subset of cleaning fluids, from the set of cleaning fluids, compatible with the second fabric type, the second subset of cleaning fluids different from the first subset of cleaning fluids; and
based on the second stain type, selecting a second cleaning fluid, from the second subset of cleaning fluids, for application onto the second region of the second garment; and
during a second stain removal cycle:
pumping a second volume of the second cleaning fluid onto the second region of the second garment adjacent the second stain via a second nozzle facing the stage, adjacent the first nozzle, and coupled to a second reservoir containing the second cleaning fluid; and
via the vacuum subsystem facing the stage opposite the second nozzle, drawing air through the second region of the second garment and the stage to remove the second cleaning fluid and stain particles of the second stain from the second garment.

10. The method of claim 1:
further comprising:
accessing a fabric thickness of the first garment;
selecting the first volume of the first cleaning fluid for application onto the first garment, the first volume proportional to the fabric thickness; and
selecting a vacuum duration for activation of the vacuum subsystem, the vacuum duration proportional to the first volume; and
wherein drawing air through the first region of the first garment and the stage to remove the first cleaning fluid and stain particles of the first stain from the first garment comprises drawing air through the first region of the first garment and the stage over the vacuum duration.

11. The method of claim 1, further comprising:
accessing an infrared image of the first region of the first garment located on the stage;
extracting a second set of features from the infrared image;
based on the second set of features:
detecting the first stain in the first region on the first garment; and
interpreting a moisture level of the first stain;
based on the moisture level of the first stain:
selecting a steaming duration inversely proportional to the moisture level; and
during the first stain removal cycle:
via a second nozzle, directing a jet of steam toward the first region of the first garment over the steaming duration to:
enhance penetration of the first cleaning fluid into fibers of the first garment; and
enhance extraction of the first stain from the first garment.

12. The method of claim 1:
further comprising, in response to closure of a cover proximal the stage, triggering an optical sensor to capture the first image of the first region of the first garment, the optical sensor:
arranged on the cover adjacent the first nozzle;
facing the stage opposite the vacuum subsystem;
facing a first side of the first region of the first garment; and
defining a field of view intersecting the stage;
wherein detecting the first stain in the first region on the first garment comprises detecting the first stain in the first region on the first side of the first garment;
wherein dispensing the first volume of the first cleaning fluid onto the first region of the first garment comprises dispensing the first volume of the first cleaning fluid onto the first region on the first side of the first garment; and
wherein drawing air through the first region of the first garment and the stage comprises drawing air through the first region of the first garment and the stage to draw the first cleaning fluid and stain particles of the first stain:
from the first side of the first garment;
through the first garment;
to a second side of the first garment opposite the first side of the first garment; and
through the stage.

13. The method of claim 1:
further comprising, in response to closure of a cover, triggering an optical sensor to capture the first image of the first region of the first garment, the optical sensor:
facing the stage opposite the cover;
facing a first side of the first region of the first garment; and
defining a field of view intersecting the stage;
wherein detecting the first stain in the first region on the first garment comprises detecting the first stain in the first region on the first side of the first garment;
wherein dispensing the first volume of the first cleaning fluid onto the first region of the first garment comprises dispensing the first volume of the first cleaning fluid onto a second side, opposite the first side, of the first garment proximal the first stain via the first nozzle arranged on the cover; and
wherein drawing air through the first region of the first garment and the stage comprises drawing air through the first region of the first garment to:
draw the first cleaning fluid from the second side of the first garment, through the first garment, to the first side of the first garment;
draw the first cleaning fluid and stain particles of the first stain off of the first side of the first garment; and
draw the first cleaning fluid and stain particles of the first stain through the stage.

14. A method comprising:
accessing a first image of a first region of a first garment located on a stage;
extracting a first set of features from the first image;
based on the first set of features:
detecting a first stain in the first region on the first garment; and
interpreting a first dimension of the first stain;
based on the first dimension, selecting a first volume of a first cleaning fluid for application onto the first region of the first garment; and
during a first stain removal cycle:
via a first nozzle facing the stage, dispensing the first volume of the first cleaning fluid onto the first region of the first garment adjacent the first stain; and
via a vacuum subsystem facing the stage opposite the first nozzle, drawing air through the first region of the first garment and the stage to remove the first cleaning fluid and stain particles of the first stain from the first garment.

15. The method of claim 14:
wherein extracting the first set of features from the first image comprises extracting the first set of features comprising a set of pixel color values from the first image; and
further comprising:
based on the set of pixel color values, interpreting a first stain type of the first stain; and
based on the first stain type, selecting the first cleaning fluid, from a set of cleaning fluids, for application onto the first region of the garment.

16. The method of claim 14, further comprising:
based on the first set of features, detecting a fabric type of the first garment;
based on the fabric type and the first stain type, selecting a steaming duration for the first garment; and
during the first stain removal cycle:
via a second nozzle, directing a jet of steam toward the first region of the first garment over the steaming duration to:
enhance penetration of the first cleaning fluid into fibers of the first garment; and
enhance extraction of the first stain from the first garment.

17. The method of claim 14, further comprising:
receiving selection of a fabric type of the first garment from a user via a user interface arranged proximal the stage;
based on the fabric type and the first stain type, queuing mechanical agitation of the first region during the first stain removal cycle; and
during the first stain removal cycle:
triggering an actuator to articulate a mechanical cleaning tool across the first region of the first garment to:
mechanically agitate fibers of the first garment;
enhance penetration of the first cleaning fluid into fibers of the first garment; and
enhance extraction of the first stain from the first region of the first garment.

18. The method of claim 14, further comprising:
in response to completion of the first stain removal cycle:
accessing a second image of the first region of the first garment located on the stage;
extracting a second set of features from the second image;
based on the second set of features, calculating a second dimension of the first stain following the first stain removal cycle;
calculating a difference between the first dimension and the second dimension; and
in response to the difference exceeding a threshold difference:
characterizing the first stain as removed from the first garment; and
prompting removal of the first garment from the stage.

19. The method of claim 14:
further comprising, in response to closure of a cover adjacent the stage, triggering an optical sensor to capture the first image of the first region of the first garment, the optical sensor:
arranged on the cover adjacent the first nozzle;
facing the stage opposite the vacuum subsystem;
facing a first side of the first region of the first garment; and
defining a field of view intersecting the stage;
wherein detecting the first stain in the first region on the first garment comprises detecting the first stain in the first region on the first side of the first garment;
wherein dispensing the first volume of the first cleaning fluid onto the first region of the first garment comprises dispensing the first volume of the first cleaning fluid onto the first region on the first side of the first garment; and
wherein drawing air through the first region of the first garment and the stage comprises drawing air through the first region of the first garment and the stage to draw the first cleaning fluid and stain particles of the first stain:
from the first side of the first garment;
through the first garment;
to a second side of the first garment opposite the first side of the first garment; and
through the stage.

20. The method of claim 14:
further comprising, in response to closure of a cover, triggering an optical sensor to capture the first image of the first region of the first garment, the optical sensor:
facing the stage opposite the cover;
facing a first side of the first region of the first garment; and
defining a field of view intersecting the stage;
wherein detecting the first stain in the first region on the first garment comprises detecting the first stain in the first region on the first side of the first garment;
wherein dispensing the first volume of the first cleaning fluid onto the first region of the first garment comprises dispensing the first volume of the first cleaning fluid onto a second side, opposite the first side, of the first garment proximal the first stain via the first nozzle arranged on the cover; and
wherein drawing air through the first region of the first garment and the stage comprises drawing air through the first region of the first garment to:
draw the first cleaning fluid from the second side of the first garment, through the first garment, to the first side of the first garment;
draw the first cleaning fluid and stain particles of the first stain off of the first side of the first garment; and
draw the first cleaning fluid and stain particles of the first stain through the stage.
